(19) United States
(12) Patent Application Publication
(10) Pub. No.: US 2015/0125774 A1
(43) Pub. Date: May 7, 2015

(54) Fuel Cell System

(71) Applicant: AFC Energy plc, Finsgate, London (GB)

(72) Inventors: James Alexander Austin, Burgess Hill (GB); Martin Thomas, Munchen (DE); Naveed Akhtar, Godalming (GB)

(21) Appl. No.: 14/400,438

(22) PCT Filed: Apr. 29, 2013
(86) PCT No.: PCT/GB2013/051087

§ 371 Date: Nov. 11, 2014

(30) Foreign Application Priority Data
May 11, 2012 (GB) 1208312.7

(51) Int. Cl. H01M 8/04

(52) U.S. Cl. CPC H01M 8/04276; H01M 8/04007
USPC 429/437; 429/451

(57) ABSTRACT

A liquid electrolyte fuel cell system (10) comprises at least one fuel cell with a liquid electrolyte chamber between opposed electrodes, the electrodes being an anode and a cathode, and means (30, 32) for supplying a gas stream to a gas chamber adjacent to the cathode and withdrawing a spent gas stream (38) from the gas chamber adjacent to the cathode, the system also comprising a liquid electrolyte storage tank (40), and means (42, 44, 47, 48) to circulate liquid electrolyte between the liquid electrolyte storage tank (40) and the fuel cells. In addition the system comprises a gas heater (50) and a humidification chamber (52) in the duct (36) leading to the said gas chamber, and means (53, 66, 68) to supply liquid electrolyte to the humidification chamber (52) so the gas is humidified by contact with the liquid electrolyte.

The present invention relates to liquid electrolyte fuel cell systems, preferably but not exclusively incorporating alkaline fuel cells.

### BACKGROUND TO THE INVENTION

Fuel cells have been identified as a relatively clean and efficient source of electrical power. Alkaline fuel cells are of particular interest because they operate at relatively low temperatures, are efficient and mechanically and electrochemically durable. Acid fuel cells and fuel cells employing other liquid electrolytes are also of interest. Such fuel cells typically comprise an electrolyte chamber separated from a fuel gas chamber (containing a fuel gas, typically hydrogen) and a further gas chamber (containing an oxidant gas, usually air). The electrolyte chamber is separated from the gas chambers using electrodes. Typical electrodes for alkaline fuel cells comprise a conductive metal, typically nickel, that provides mechanical strength to the electrode, and the electrode also incorporates a catalyst coating which may comprise activated carbon and a catalyst metal, typically platinum.

In operation, chemical reactions occur at each electrode, generating electricity. For example, if a fuel cell is provided with hydrogen gas and with air, supplied respectively to an anode chamber and to a cathode chamber, the reactions are as follows, at the anode:

H₂+2 OH⁻→2 H₂O+2 e⁻;

and at the cathode:

½O₂+H₂O+2 e⁻→2 OH⁻

so that the overall reaction is hydrogen plus oxygen giving water, but with simultaneous generation of electricity, and with diffusion of hydroxyl ions from the cathode to the anode through the electrolyte. Problems can arise due to changes in the concentration of the electrolyte, as although water is created by the reaction occurring at the anode, water also evaporates at both electrodes. Such evaporation can be a particular problem at the cathode, as water not only evaporates but is also used up in the electrochemical reaction.

### DISCUSSION OF THE INVENTION

The fuel cell system of the present invention addresses or mitigates one or more problems of the prior art.

According to the present invention there is provided a liquid electrolyte fuel cell system comprising at least one fuel cell, each fuel cell comprising a liquid electrolyte chamber between opposed electrodes, the electrodes being an anode and a cathode, and means for supplying a gas stream through a duct to a gas chamber adjacent to an electrode, the system also comprising a liquid electrolyte storage tank, and means to supply liquid electrolyte from the liquid electrolyte storage tank to each liquid electrolyte chamber;
wherein the system comprises a gas heater and a humidification chamber in the duct leading to the said gas chamber, and means to supply liquid electrolyte to the humidification chamber so the gas is humidified by contact with the liquid electrolyte.

In use the gas heater preferably raises the temperature of the gas to within 5° C. of the operating temperature of the fuel cell or cells, more preferably within 2° C. This may be an electrical heater, or alternatively may involve heat exchange with a heated fluid, for example with electrolyte that has circulated through the fuel cell or cells. This may involve direct or indirect heat transfer.

The humidification chamber may be separate from the gas heater, or integral with it. Preferably the humidification chamber is designed not to impose a large pressure drop on the gas flowing through it. For example, although bubbling is an effective way of bringing a gas into contact with a liquid, it inevitably introduces a pressure drop, if only because of the depth below the surface of the liquid at which the bubbles are formed. If bubbles are formed at a depth of 50 mm below the surface this requires a pressure of at least 500 Pa. One design of humidification chamber incorporates a plurality of baffles that are aligned with the gas flow direction to define gas flow channels, means to cause electrolyte to flow over surfaces of the baffles, and means to collect a pool of electrolyte at the bottom of each gas flow channel. The depth of liquid in such a pool of electrolyte may be maintained by a weir or overflow.

The liquid electrolyte supplied to the humidification chamber may be electrolyte that has passed through the fuel cell or cells, or may be electrolyte tapped off from electrolyte supplied to the fuel cell or cells.

It has been found that in operation of a fuel cell system without use of the present invention, there is a net evaporation of water from the electrodes, in particular from the cathode, which may lead to the formation of crystalline potassium hydroxide or potassium carbonate in pores in the electrode if the electrolyte is an aqueous solution of potassium hydroxide. This hinders mass transport for the gaseous reactants. The system of the invention significantly reduces loss of water by evaporation, as the gas flow treated by the invention is humidified with water vapour from electrolyte at a temperature close to the operating temperature, suppressing the risk of solid material being formed in the electrode from the material of the electrolyte.

The system preferably includes the humidification chamber in the gas duct leading to the cathode. A similar humidification chamber may also be provided in the gas duct leading to the anode.

The invention will now be further and more particularly described, by way of example only, and with reference to the accompanying drawings in which:

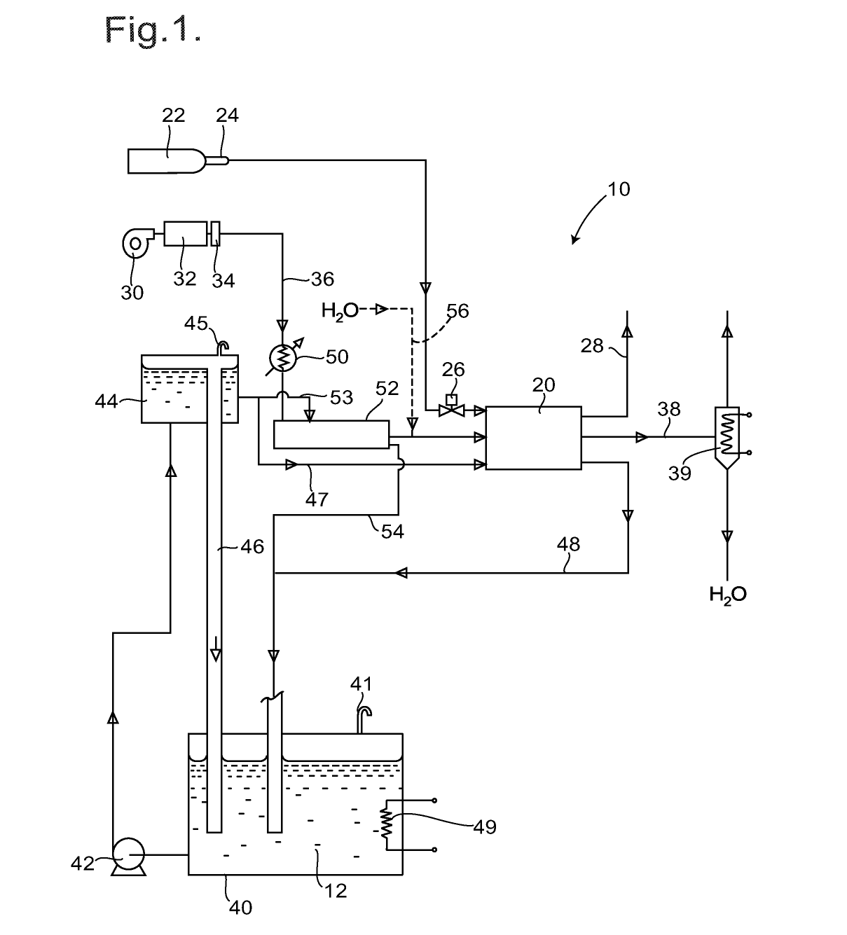

FIG. 1 shows a schematic diagram of the fluid flows of a fuel cell system of the invention;

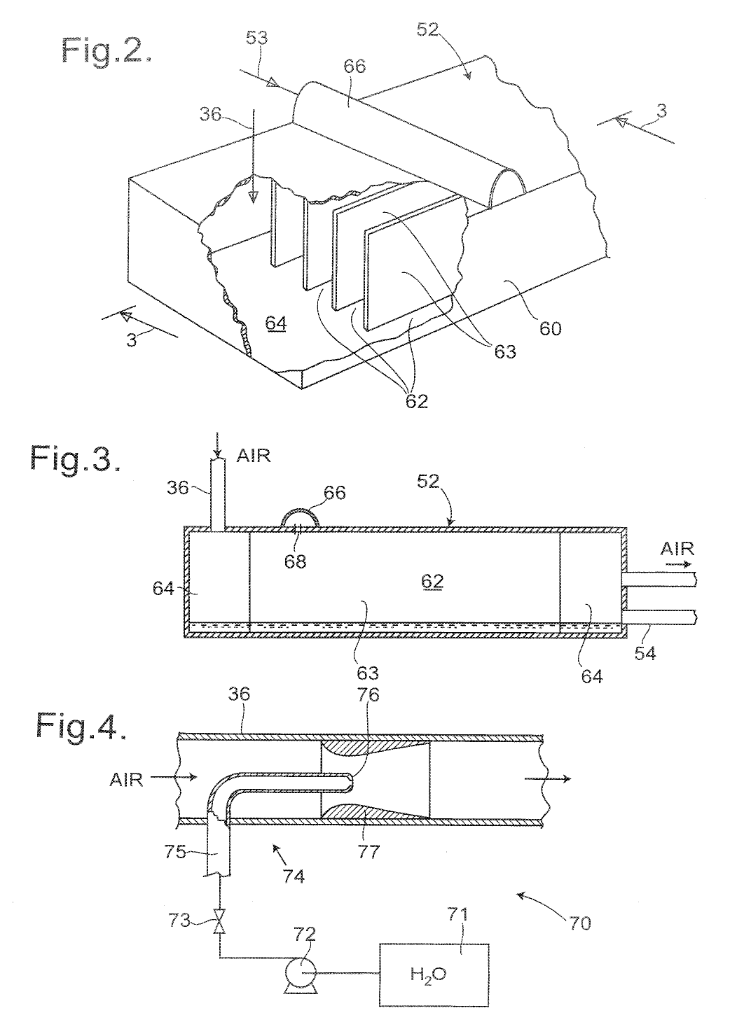

FIG. 2 shows a perspective view of a humidification chamber of the fuel cell system of FIG. 1, partly broken away;

FIG. 3 shows a longitudinal sectional view of the humidification chamber of FIG. 2, on the line 3-3; and

FIG. 4 shows a longitudinal sectional view of an additional humidification device.

Referring to FIG. 1, a fuel cell system 10 includes a fuel cell stack 20 (represented schematically), which uses aqueous potassium hydroxide as electrolyte 12, for example at a concentration of 6 moles/litre. The fuel cell stack 20 is supplied with hydrogen gas as fuel, air as oxidant, and electrolyte 12, and operates at an electrolyte temperature of about 65° or 70° C. Hydrogen gas is supplied to the fuel cell stack 20 from a hydrogen storage cylinder 22 through a regulator 24 and a control valve 26, and an exhaust gas stream emerges through a first gas outlet duct 28. Air is supplied by a blower 30, and any CO₂ is removed by passing the air through a scrubber 32 and a filter 34 before the air flows through a duct 36 to the fuel cell stack 20, and spent air emerges through a second gas outlet duct 38.

The fuel cell stack 20 is represented schematically, as its detailed structure is not the subject of the present invention, but in this example it consists of a stack of fuel cells, each fuel cell comprising a liquid electrolyte chamber between opposed electrodes, the electrodes being an anode and a cathode. In each cell, air flows through a gas chamber adjacent to the cathode, to emerge as the spent air. Similarly, in each cell, hydrogen flows through a gas chamber adjacent to the anode, and emerges as the exhaust gas stream.

Operation of the fuel cell stack 20 generates electricity, and also generates water by virtue of the chemical reactions described above. In addition water evaporates in both the anode and cathode gas chambers so both the exhaust gas stream and the spent air contain water vapour. The rate of evaporation depends on the electrode surface area exposed to reactant gases, the flow rate of the reactant gases, and the operating temperature. It also depends on the partial pressure of water vapour in the anode and cathode gas chambers. The overall result would be a steady loss of water from the electrolyte 12; the loss of water can be prevented by condensing water vapour from the spent air in the outlet duct 38 (or from the exhaust gas), for example by providing a condenser 39. In addition, the chemical reaction occurring at the cathode generates hydroxyl ions and consumes water, so concentrating the electrolyte in the vicinity of the cathode.

The electrolyte 12 is stored in an electrolyte storage tank 40 provided with a vent 41. A pump 42 circulates electrolyte from the storage tank 40 into a header tank 44 provided with a vent 45, the header tank 44 having an overflow pipe 46 so that electrolyte returns to the storage tank 40. This ensures that the level of electrolyte in the header tank 44 is constant. The electrolyte is supplied at constant pressure through a duct 47 to the fuel cell stack 20; and spent electrolyte returns to the storage tank 40 through a return duct 48. The storage tank 40 includes a heat exchanger 49 to remove excess heat.

In the duct 36 the air stream passes through a heat exchanger 50, and then a humidification chamber 52. Electrolyte is tapped off from the duct 47 through a duct 53, and is fed into the humidification chamber 52. Electrolyte that has flowed through the humidification chamber 52 emerges through an electrolyte outflow duct 54 and is returned to the storage tank 40.

In a modification, the heat exchanger 50 may be fed with electrolyte from the return duct 48, so that the air supplied to the fuel cell stack 20 exchanges heat with the electrolyte that has flowed through the fuel cell stack 20. In another modification, electrolyte is tapped off from the return duct 48 (rather than the supply duct 47), by the duct 53, to be fed to the humidification chamber 52. In this case the humidification chamber 52 may be sufficiently warm that no separate heat exchanger 50 is required: the humidification chamber 52 both heats and humidifies the air stream at the same time, by direct contact with electrolyte.

Referring now to FIGS. 2 and 3, the humidification chamber 52 consists of a generally rectangular housing 60 subdivided into several flow channels 62 (five are shown in FIG. 2) by parallel baffles 63 which extend from the top wall to just above the bottom wall of the housing 60. The baffles 63 do not extend to the ends of the housing 60, so there is a gas distribution space 64 at each end. The duct 36 supplying air to the humidification chamber 52 communicates with the gas distribution space 64 at one end (the left-hand end as shown) through the top wall of the housing 60, while the duct that takes humidified air to the fuel cell stack 20 communicates with the gas distribution space 64 at the opposite end, through the end wall of the housing 60.

Electrolyte 12 is supplied to the humidification chamber 52 through a duct 66 which is connected to the duct 53 carrying the electrolyte 12. The duct 66 extends across the top of the housing 60, and communicates with the flow channels 62 through small apertures 68 (see FIG. 3) through the top wall of the housing 60 above the baffles 63, near the left-hand end of the baffles 63 as shown. The apertures 68 are typically of diameter between 0.5 and 3 mm, for example 1.5 mm. Electrolyte forms a curtain of droplets or liquid jets, falling from the apertures 68 into the flow channels 62, through which the air must flow, and the electrolyte also trickles down the baffles 63. The electrolyte collects as a pool at the bottom of the housing 60. The baffles 63 do not contact the bottom wall, so the pool of electrolyte is continuous, and is not divided by the baffles 63. The outflow duct 54 communicates with the end wall of the housing 60 at the right-hand end (as shown) at such a position as to ensure there is a consistent depth of electrolyte 12 at the bottom of the housing 60, which may for example be 10 mm. The electrolyte then flows out of the duct 54 to be returned to the tank 40, as described above.

The humidification chamber 52 provides satisfactory humidification of the air flow unless the air flow is too high, as a higher air flow rate reduces the contact time of the air with the aqueous electrolyte within the humidification chamber 52, and so reduces the degree of humidification.

It will be appreciated that the fuel cell system 10 described above may be modified in various ways while remaining within the scope of the present invention. For example the number of flow channels 62 and the dimensions of the flow channels 62 may be different from that described. The invention may be operated such that the gas stream is heated to the operating temperature of the fuel cell or cells, and that the stream is saturated with water vapour at that operating temperature. Alternatively the gas stream may be heated to a temperature slightly above the operating temperature, thereby enhancing its capacity to carry water vapour, and reducing the degree of condensation that may otherwise occur in the air duct 36 between the humidification chamber 52 and the fuel cell stack 20.

The gas stream may not be saturated with water vapour after passage through the humidification chamber 52, but should be humidified to achieve a relative humidity at least 65%, or above 75%, or above 80%, as it emerges from the chamber 52. It will be appreciated that humidification of the air stream decreases the partial pressure of oxygen in the air stream, so affecting the performance of the fuel cell stack 20. The degree of humidification therefore must be selected to optimise both the performance of the fuel cell stack 20 and its longevity.

If the degree of humidification achieved by the humidification chamber 52 is insufficient, additional water may be sprayed into the duct 36 carrying humidified air, between the humidification chamber 52 and the fuel cell stack 20, via a duct 56; this is indicated as a broken line. The water may be introduced through a spray nozzle so that droplets in the form of a fine mist are distributed throughout the humidified air flowing through the duct 36 downstream of the humidification chamber 52.

Referring now to FIG. 4, this shows a spray injection system 70 which may correspond to the duct 56 which is used to introduce droplets of water. A reservoir 71 contains water, which is preferably at the same temperature as the electrolyte. This is connected via a pump 72 and a flow control valve 73 to an injection nozzle 74. The injection nozzle 74 is shown in longitudinal cross-section, and consists of a tube 75 extending along the axis of the duct 36 carrying air from the humidification chamber 52 to the fuel cell stack 20, the tube 75 tapering to a narrow orifice 76. The tube 75 is installed such that the orifice 76 is at the centre of a venturi-shaped constriction 77 within the duct 36. The arrangement is such that water droplets in the form of a fine mist are distributed throughout the air flowing through the duct 36, the constriction 77 helping to ensure thorough mixing of the mist of droplets into the air stream.

It is desirable for there to be sufficient distance along the duct 36 between the spray injection system 70 and the fuel cell stack 20 to ensure that all the droplets have evaporated by the time the air reaches the cathode compartments within the fuel cell stack 20. This may be assisted by preheating the air stream.

It will be appreciated that the fuel cell system 10 is described by way of example only. Various alternatives and modifications may be made to the system 10. For example, the humidification chamber 52 may be located within the storage tank 40; or indeed the humidification chamber 52 may be at least part of the electrolyte storage tank 40, so as an alternative the air stream may be humidified by being passed through the electrolyte storage tank 40. The spray injection system 70 may be used in place of the humidification chamber 52, instead of being used in conjunction with it.

A potential benefit of using the electrolyte as the liquid for humidifying the gas stream is that not only is water loss by evaporation suppressed, but in addition the gas stream may carry a small amount of electrolyte, whether as vapour or small droplets, that is to say potassium hydroxide in this example. This may assist in creating an ionic/electronic conducting network within the electrode.

What is claimed:

1. A liquid electrolyte fuel cell system comprising at least one fuel cell, each fuel cell comprising a liquid electrolyte chamber between opposed electrodes, the electrodes being an anode and a cathode, and means for supplying a gas stream through a duct to a gas chamber adjacent to an electrode, the system also comprising a liquid electrolyte storage tank, and means to supply liquid electrolyte from the liquid electrolyte storage tank to each liquid electrolyte chamber;
wherein the system comprises, in the duct leading to the gas chamber, a gas heater and a humidification chamber, and means to supply liquid electrolyte to the humidification chamber so the gas is humidified by contact with the liquid electrolyte; wherein the humidification chamber is selected from:
a) a housing comprising a plurality of baffles that are aligned with the gas flow direction to define gas flow channels, means to cause electrolyte to flow over surfaces of the baffles, and means to collect a pool of electrolyte at the bottom of each gas flow channel; or
b) a portion of the duct comprising a venturi-shaped constriction within the duct, with a spray nozzle that defines a narrow orifice at the centre of the venturi-shaped constriction.

2. A fuel cell system as claimed in claim 1 wherein the gas heater raises the temperature of the gas to within 5° C. of the operating temperature of the fuel cell or cells.

3. A fuel cell system as claimed in claim 1 wherein the gas heater heats the gas by heat exchange with a fluid.

4. A fuel cell system as claimed in claim 3 wherein the fluid used for heat exchange is electrolyte that has flowed through the fuel cell or cells.

5. A fuel cell system as claimed in claim 1 wherein the gas heater heats the gas by direct contact with the liquid electrolyte, so the gas is heated and humidified at the same time.

6. (canceled)

7. A fuel cell system as claimed in claim 1 wherein the liquid electrolyte supplied to the humidification chamber is electrolyte that has passed through the fuel cell or cells, or is electrolyte tapped off from electrolyte supplied to the fuel cell or cells.

8. A fuel cell system as claimed in claim 1 wherein the humidification chamber is provided in a gas duct leading to the cathode.

9. A fuel cell system as claimed in claim 1 wherein the humidification chamber is provided in a gas duct leading to the anode.

10. A fuel cell system as claimed in claim 1 wherein the humidification chamber is within the storage tank.

11. (canceled)

12. A fuel cell system as claimed in claim 1 in which the humidification chamber comprises the housing, wherein the system also comprises a spray nozzle for spraying additional water into the duct carrying the humidified gas from the humidification chamber to the gas chamber.

13. A fuel cell system as claimed in claim 12 also comprising a venturi-shaped constriction within the duct carrying the humidified gas from the humidification chamber to the gas chamber, wherein the spray nozzle defines a narrow orifice at the centre of the venturi-shaped constriction.
